(19) United States
(12) Patent Application Publication
(10) Pub. No.: US 2012/0091823 A1
(43) Pub. Date: Apr. 19, 2012

(54) MOBILE STORAGE DEVICE AND METHOD FOR MANAGING POWER CONSUMPTION OF THE MOBILE STORAGE DEVICE

(75) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/115,117

(22) Filed: May 25, 2011

(30) Foreign Application Priority Data
Oct. 18, 2010 (CN) 201010510106.8

(51) Int. Cl. H01H 43/00

(52) U.S. Cl. 307/125

(57) ABSTRACT

In a method for managing power consumption of a mobile storage device, the mobile storage device includes a power switch, a timer, and a universal serial bus (USB) port. The method detects whether the USB port has a data transmission signal from the electronic device. The method further drives the timer to determine a time period of how long the USB port has no data transmission signal from the electronic device, and determines whether the time period is equal to a predetermined time. In addition, the method controls the power switch to switch on when the USB port has the data transmission signal from the electronic device, and controls the power switch to switch off when the time period is equal to the predetermined time.

### BACKGROUND

1. Technical Field

Embodiments of the present disclosure relate to storage devices, and particularly to a mobile storage device and a method for managing power consumption of the mobile storage device.

2. Description of Related Art

When people want to save energy in the world, it is essential to provide means of energy conservation in products. To realize this, a number of energy reducing products have been developed, such as computing devices, or display devices. Mobile storage device (e.g., USB flash drives) are very useful and convenient. When a user has a USB flash drive and wants to store data on drive, he/she must plug the USB flash drive into an electronic device, such as a computer, for example.

In order to save power used by the computer connected to the USB drive, it is a known practice to immediately pull the USB drive from the computer after the operation is paused or finished. However, this method is inconvenient and may cause wear and tear on both the USB drive and the USB connector.

### BRIEF DESCRIPTION OF THE DRAWINGS

FIG. 1 is a block diagram of one embodiment of a mobile storage device.

FIG. 2 is a block diagram illustrating function modules of a power control unit embedded in the mobile storage device of FIG. 1.

FIG. 3 is a flowchart of one embodiment of a method for managing power consumption of the mobile storage device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

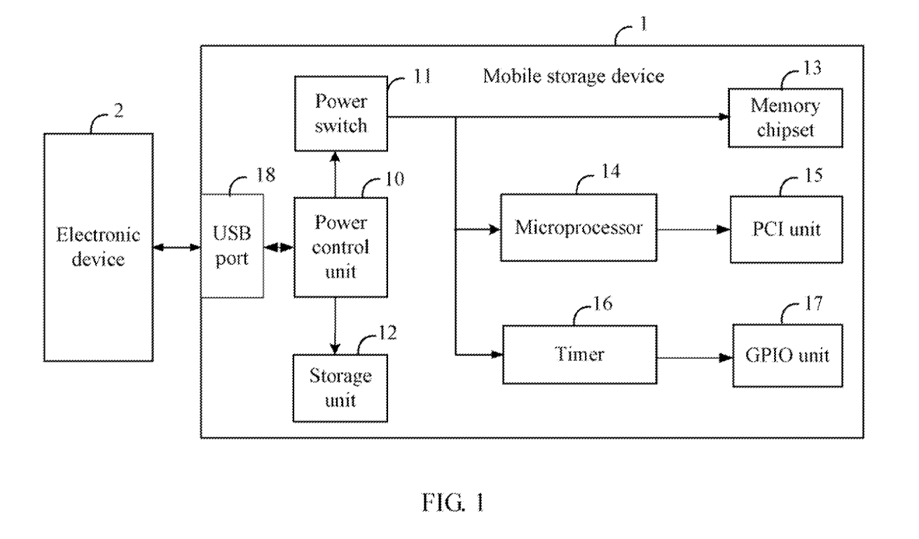

FIG. 1 is a block diagram of one embodiment of a mobile storage device 1. In the embodiment, the mobile storage device 1 can be connected to an electronic device 2 for exchanging data with the electronic device 2, and power consumption of the mobile storage device 1 can be managed during operation of the mobile storage device 1. In one embodiment, the mobile storage device 1 includes a power control unit 10, a power switch 11, a storage unit 12, a timer 16, and a universal serial bus (USB) port 18. The mobile storage device 1 may further include a memory chipset 13, a microprocessor 14, a peripheral component interconnect (PCI) unit 15, and a general purpose input/output (GPIO) unit 17. It should be understood that FIG. 1 illustrates only one example of the mobile storage device 1 that may include more or fewer components than illustrated, or a different configuration of the various components in other embodiments.

The electronic device 2 provides power to the mobile storage device 1 when the mobile storage device 1 is plugged into USB port 18. In one embodiment, the electronic device 2 may be, but not limited to, a personal computer, a notebook computer, or a camera device.

The power switch 11 connects to the memory chipset 13, the microprocessor 14, the PCI unit 15, and the timer 16. The electronic device 2 provides power to each of the components 13-16 through the power switch 11 when each of the components operates normally. The power control unit 10 detects whether the USB port 18 has a data transmission signal from the electronic device 2, controls the power switch 11 to switch on when the USB port 18 has a data transmission signal, and controls the power switch 11 to switch off when the USB port 18 have no data transmission signal, to reduce power consumption of the electronic device 2 when the mobile storage device 1 is not currently exchanging data. The mobile storage device 1 may be an external hard disk, a storage card, or some other data storage medium.

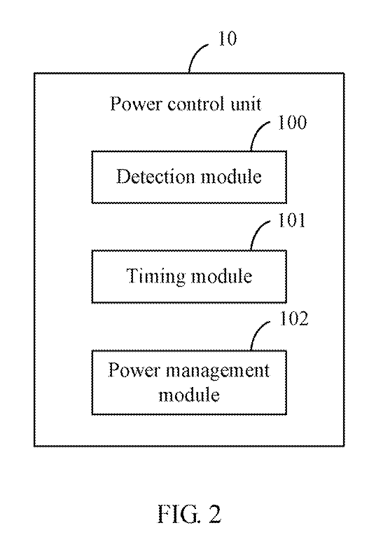

FIG. 2 is a block diagram illustrating function modules of the power control unit 10 embedded in the mobile storage device of FIG. 1. In one embodiment, the power control unit 10 includes a detection module 100, a timing module 101, and a power management module 102. The modules 100-102 may comprise computerized code in the form of one or more programs that are stored in the storage unit 12. The computerized code includes instructions that are executed by the microprocessor 14 to provide functions for implementing the modules. In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

The detection module 100 is operable to detect whether the USB port 18 has a data transmission signal from the electronic device 2. In the embodiment, the detection module 100 determines that the USB port 18 has the data transmission signal when a voltage level of the USB port 18 is at a high voltage level (e.g., 5 volts), and determines that the USB port 18 has no data transmission signal when the voltage level of the USB port 18 is at a low voltage level (e.g., 0 volts).

The timing module 101 is operable to drive the timer 16 to determine a time period of how long the USB port 18 has no data transmission signal from the electronic device 2, and determine whether the time period is equal to a predetermined time. In the embodiment, the predetermined time may be set to values of seconds (e.g., 2 seconds) according to user requirements, and pre-stored in the storage unit 12.

The power management module 102 is operable to control the power switch 11 to switch on when the USB port 18 has the data transmission signal from the electronic device 2, so that the mobile storage device 1 can exchange data normally using the power supplied by the electronic device 2. The power management module 102 is further operable to control the power switch 11 to switch off when the time period is equal to the predetermined time, so that the mobile storage device 1 does not continue to use power from the electronic device 2 unnecessarily.

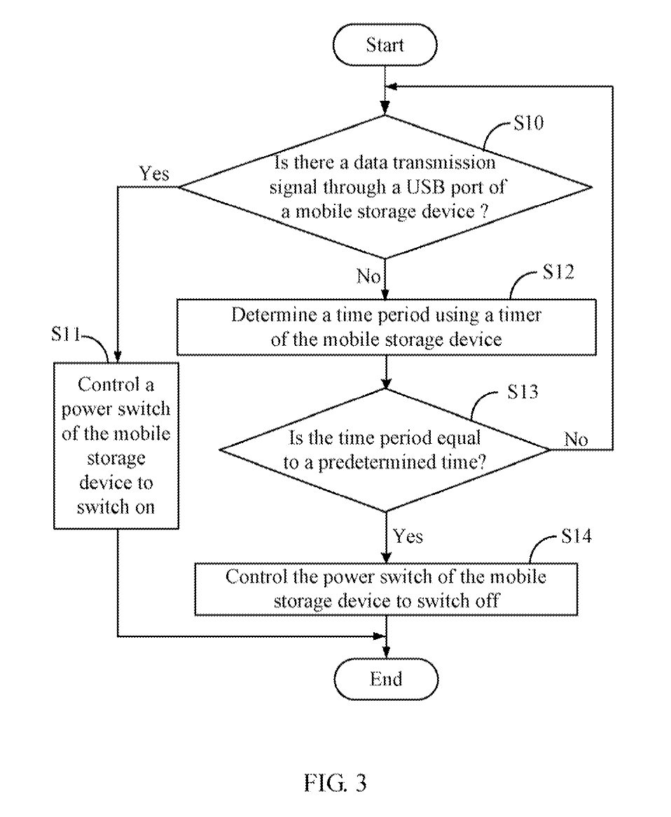

FIG. 3 is a flowchart of one embodiment of a method for managing power consumption of the mobile storage device 1 of FIG. 1. In the embodiment, the mobile storage device 1 may be connected to the electronic device 2 for data exchange, and power consumption of the mobile storage device 1 can be reduced during non-operating of the mobile storage device 1 even though it may still be connected the electronic device 2. Depending on the embodiment, additional blocks may be added, others removed, and the ordering of the blocks may be changed.

In block S10, the detection module 100 detects whether the USB port 18 has a data transmission signal from the electronic device 2. In the embodiment, the detection module 100 determines that the USB port 18 has the data transmission signal when a voltage level of the USB port 18 is at a high voltage level (e.g., 5 volts), and determines that the USB port 18 has no data transmission signal when the voltage level of the USB port 18 is at a low voltage level (e.g., 0 volts). If the USB port 18 has a data transmission signal from the electronic device 2, block S11 is implemented. Otherwise, if the USB port 18 has no data transmission signal from the electronic device 2, block S12 is implemented.

In block S11, the power management module 102 controls the power switch 11 to switch on when the USB port 18 has the data transmission signal from the electronic device 2, so that the mobile storage device 1 can exchange data normally using the power supplied by the electronic device 2.

In block S12, the timing module 101 drives the timer 16 to determine a time period of how long the USB port 18 has no data transmission signal from the electronic device 2. In block S13, the timing module 101 determines whether the time period is equal to a predetermined time. In the embodiment, the predetermined time may be set as a value of seconds (e.g., 2 seconds) according to user requirements, and pre-stored in the storage unit 12. If the time period is less than the predetermined time, block S10 is repeated. Otherwise, if the time period is equal to the predetermined time, block S14 is implemented.

In block S14, the power management module 102 controls the power switch 11 to switch off when the time period is equal to the predetermined time, so that the mobile storage device 1 consumes less power from the electronic device 2 during inactive periods of the mobile storage device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile storage device, comprising:
a power switch;
a timer connected to the power switch;
a universal serial bus (USB) port operable to connect the mobile storage device with an electronic device; and
a power control unit, comprising:
a detection module operable to detect whether the USB port has a data transmission signal from the electronic device;
a timing module operable to drive the timer to determine a time period of how long the USB port has no data transmission signal from the electronic device, and determine whether the time period is equal to a predetermined time; and
a power management module operable to control the power switch to switch on when the USB port has the data transmission signal from the electronic device, or control the power switch to switch off when the time period is equal to the predetermined time.

2. The mobile storage device according to claim 1, wherein the detection module determines that the USB port has the data transmission signal upon the condition that a voltage level of the USB port is at a high voltage level.

3. The mobile storage device according to claim 1, wherein the detection module determines that the USB port has no data transmission signal upon the condition that the voltage level of the USB port is at a low voltage level.

4. The mobile storage device according to claim 1, wherein the predetermined time is preset according to user requirements.

5. The mobile storage device according to claim 1, wherein the electronic device provides power to the mobile storage device when the mobile storage device is plugged into the electronic device through the USB port.

6. A method for managing power consumption of a mobile storage device, the mobile storage device comprising a power switch, a timer, and a universal serial bus (USB) port, the method comprising:
detecting whether the USB port has a data transmission signal from an electronic device that is connected to the mobile storage device through the USB port;
driving the timer to determine a time period of how long the USB port has no data transmission signal from the electronic device;
determining whether the time period is equal to a predetermined time; and
controlling the power switch to switch off when the time period is equal to the predetermined time, or returning to the detecting step when the time period is less than the predetermined time.

7. The method according to claim 6, further comprising:
controlling the power switch to switch on if the USB port has the data transmission signal from the electronic device.

8. The method according to claim 6, wherein the detecting step comprises:
determining that the USB port has the data transmission signal upon the condition that a voltage level of the USB port is at a high voltage level; or
determining that the USB port has no data transmission signal upon the condition that the voltage level of the USB port is at a low voltage level.

9. The method according to claim 6, wherein the predetermined time is preset according to user requirements.

10. The method according to claim 6, wherein the electronic device provides power to the mobile storage device when the mobile storage device is plugged into the electronic device through the USB port.

11. A non-transitory storage medium having stored thereon instructions that, when executed by at least one microprocessor of a mobile storage device, causes the mobile storage device to perform for managing power consumption of the mobile storage device, the mobile storage device comprising a power switch, a timer, and a universal serial bus (USB) port, the method comprising:
detecting whether the USB port has a data transmission signal from an electronic device that is connected to the mobile storage device through the USB port;
driving the timer to determine a time period of how long the USB port has no data transmission signal from the electronic device;
determining whether the time period is equal to a predetermined time; and
controlling the power switch to switch off when the time period is equal to the predetermined time, or returning the detecting step when the time period is less than the predetermined time.

12. The storage medium according to claim 11, wherein the method further comprises:
controlling the power switch to switch on if the USB port has the data transmission signal from the electronic device.

13. The storage medium according to claim 11, wherein the detecting step comprises:
determining that the USB port has the data transmission signal upon the condition that a voltage level of the USB port is at a high voltage level; or
determining that the USB port has no data transmission signal upon the condition that the voltage level of the USB port is at a low voltage level.

14. The storage medium according to claim 11, wherein the predetermined time is preset according to user requirements.

15. The storage medium according to claim 11, wherein the electronic device provides power to the mobile storage device when the mobile storage device is plugged into the electronic device through the USB port.
